(19) United States
(12) Patent Application Publication
(10) Pub. No.: US 2023/0089945 A1
(43) Pub. Date: Mar. 23, 2023

(54) CONTROLLER DESIGN USING STABILITY REGION

(71) Applicants: Advanced Energy Industries, Inc., Fort Collins, CO (US); Colorado State University Research Foundation, Fort Collins, CO (US)

(72) Inventors: Chad S. Samuels, Fort Collins, CO (US); Peter Young, Fort Collins, CO (US)

(21) Appl. No.: 17/483,037

(22) Filed: Sep. 23, 2021

(51) Int. Cl. H02P 9/02; G05B 13/04

(52) U.S. Cl. CPC H02P 9/02; G05B 13/041

(57) ABSTRACT

This disclosure describes systems, methods, and apparatus for designing and using an H_{˜} controller. The controller can be used in an RF power generation system for providing multi-level pulsed waveforms to a plasma load, where robust controller design is desired. This can be achieved through a two phase optimization for the controller based on a first phase of H_{∞} loopshaping based on one or more first performance metrics, that acts as a sub-routine within a second phase or larger optimization loop that simulates the controller designed by the H_{∞} loopshaping and optimizes based on one or more second performance metrics that may include one or more of the first performance metrics.

### FIELD OF THE DISCLOSURE

The present disclosure relates generally to controller design. In particular, but not by way of limitation, the present disclosure relates to systems, methods and apparatuses for designing a controller using a “stability region” as a performance metric to be optimized.

### DESCRIPTION OF RELATED ART

Some radio frequency (RF) power generation systems use an integral control mechanism to optimize target power tracking. This mechanism recalls a last control value from a previous state when starting a new state, which can be effective for linear loads, but becomes a source of instability, chaos, and bifurcation for non-linear loads, such as plasma loads. In particular, during the time in which the controller saves a last control value to memory and then recalls this value for controlling a start of the next state, the load condition may have changed since non-linear loads can be chaotic. The result may be a response to the control value at the start of the state that is far from expected. FIG. 1A shows a pulsing power waveform with three repeating states provided to a linear load via integral control, where the solid line shows the target waveform, and the dotted line shows the actual power delivered by the system. FIG. 1B shows the same waveform delivered to a non-linear load and the resulting transients that can occur when integral control is used. This particular example shows overshoot of the target waveform caused by the integrator recalling a stored previous control state while the load changed between storage of that state and the controller's recalling of that state during a time δt (e.g., Clegg integrator). Not only is this an unstable condition, but the overshoot can trigger the power generation system's clamping/protection mechanism. This form of integral control is also slow and fails to control based on an average basis. A setpoint modifier can be arranged between the user interface and the integral controller, but even then it can take several cycles for tracking to converge on the target waveform, and where different states have different durations, the averaging nature of integral control leads to lower accuracy in the short states.

### SUMMARY OF THE DISCLOSURE

These challenges are overcome by design and introduction of an H_{∞} controller into the power generation system. In particular, the power generation system can be modeled as a plant G(s) with a closed-loop feedback controller K(s) where the plant and controller are related at least via weights W(s). Initial parameters and weights W(s) for this model can be selected as initial guesses and then passed, along with one or more first performance metrics (e.g., controller speed and tracking error), to an optimization algorithm. This optimization includes two phases starting with an H_{∞} loopshaping optimization that produces an optimized controller K′_{N}(s), where N is a number of a current loop of the optimization starting with 1. The optimized controller, starting with K′₁(s), can be passed to a second phase of the optimization that includes a test or simulation of the optimized controller to see how it performs relative to one or more second performance metrics (which may, but does not have to, include one or more of the first performance metrics). The simulation can be performed in a software-based model, on an actual physical implementation of the power generation system, or on a combination of software and the hardware version of the power generation system. The resulting data from the simulation can be analyzed relative to the one or more second performance metrics to determine if the optimized controller, K′₁(s), is an optimized solution. Typically, at least a few optimization loops are carried out before the optimization converges on an optimal solution for the controller K′(s). Accordingly, after analyzing simulation results for the first optimized controller K′₁(s), the optimization can select new parameters and weights and re-run the two phases of the optimization. In particular, the H_{∞} loopshaping optimization forms a second optimized controller K′₂(s), which is then sent through the simulation and the resulting data analyzed to quantify whether the solution is approaching a convergence. Comparing the results from the first two simulations provides a means to determine which direction to head with a next set of parameters and weights and to then produce a third optimized controller K′₃(s). This looping can continue until convergence occurs, or until the simulation results between two or more optimized controllers K′_{N}(s) are within a threshold of each other. When this occurs, a latest optimized controller K′_{N}(s) can be selected as the final design, and programmed into the power generation system (e.g., into an FPGA for controlling a DC section's rail voltage and an RF power amplifier's drive or phase voltage).

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Some embodiments of the disclosure may be characterized as a generator including a power generation section, a match network, and a control section. The match network can be coupled to an output of the power generation section. The control section can be configured to receive a target waveform and can be configured to receive feedback from an output of the generator. The control section can include an optimized controller designed using a two-part optimization where each iteration of the optimization sees (1) a first optimization for a model controller based on a first one or more performance metrics that forms an optimized controller K′_{N}(s), and (2) a second optimization of weights for the optimized controller based on a second one or more performance metrics, where N identifies the iteration. The optimized controller can receive the feedback and the target waveform, and can control an output of the power generation section based on the feedback and the target waveform.

Other embodiments of the disclosure may also be characterized as a method including forming a model for a controller of a power supply configured to delivery power to a strongly nonlinear and/or chaotic plasma load. The method also includes selecting a first one or more performance metrics for optimizing the controller and selecting initial guesses of weights and parameters of the model. The method also includes performing an initial H_{∞} loopshaping optimization of the model where the weight and parameters of the model are variables to be optimized to form an optimized model of the controller. The method further includes simulating the optimized model of the controller for a range of power setpoints and cable lengths between the power supply and the strongly nonlinear and/or chaotic plasma load to form a stability region grid comprising a grid of stable and unstable points. The method further includes selecting a second one or more performance metrics, and analyzing the stability region grid to quantify performance of the optimized model of the controller in terms of the second one or more performance metrics. The method yet further includes selecting new weights and parameters for the model and repeating the performing, the simulating, the selecting, and the analyzing, until performance of the optimized model of the controller converges.

Other embodiments of the disclosure can be characterized as a non-transitory, tangible computer readable storage medium, encoded with processor readable instructions to perform a method for designing an H_{∞} controller. The method includes forming a model for a controller of a power supply configured to delivery power to a strongly nonlinear and/or chaotic plasma load. The method also includes selecting a first one or more performance metrics for optimizing the controller and selecting initial guesses of weights and parameters of the model. The method also includes performing an initial H_{∞} loopshaping optimization of the model where the weight and parameters of the model are variables to be optimized to form an optimized model of the controller. The method further includes simulating the optimized model of the controller for a range of power setpoints and cable lengths between the power supply and the strongly nonlinear and/or chaotic plasma load to form a stability region grid comprising a grid of stable and unstable points. The method further includes selecting a second one or more performance metrics, and analyzing the stability region grid to quantify performance of the optimized model of the controller in terms of the second one or more performance metrics. The method yet further includes selecting new weights and parameters for the model and repeating the performing, the simulating, the selecting, and the analyzing, until performance of the optimized model of the controller converges

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1A shows a pulsing power waveform with three repeating states provided to a linear load via integral control, where the dashed line shows the target waveform, and the solid line shows the actual power delivered by the system;

FIG. 1B shows the same waveform delivered to a non-linear load and the resulting transients that can occur when integral control is used;

FIG. 2 shows an embodiment of a method for designing an H_{∞} controller using a two-phase optimization;

FIG. 3 shows an alternative to FIG. 2, where the test/simulation is bifurcated between software and hardware test beds based on the second phase approaching a convergence;

FIG. 4 illustrates a plasma processing system implementing the H_{∞} controller found via method 200 or 300;

FIG. 5 provides additional details of the control section and the power generation and sensors of FIG. 4;

FIG. 6 illustrates a stability region grid calculated from a first optimized controller, and annotated to show a calculation of stability region size at a particular power setpoint;

FIG. 7A illustrates a stability region grid calculated from a second optimized controller and showing a stability region area between the setpoints of 800 and 1000 W;

FIG. 7B illustrates another stability region grid calculated from a third optimized controller and having a larger stability region area between the setpoints of 800 and 1000 W;

FIG. 8 shows an H_{∞} optimal control problem used in the optimizations of this disclosure;

FIG. 9 shows an example target waveform and tracking waveform that can be used in the test/simulation of the second phase of the optimizations disclosed herein; and

FIG. 10 shows physical components that may be utilized to realize the H_{∞} controller (and the control section 412 or 510 generally) according to an exemplary embodiment.

### DETAILED DESCRIPTION

To overcome the challenges of providing power to a non-linear load, the present disclosure describes systems, methods, and apparatus for designing a more robust controller using a two-phase optimization comprising a H_{∞} loopshaping optimization followed by a determination and quantification of a “stability region.” These two phases are looped until the stability region converges.

The word “exemplary” is used herein to mean “serving as an example, instance, or illustration.” Any embodiment described herein as “exemplary” is not necessarily to be construed as preferred or advantageous over other embodiments.

Preliminary note: the flowcharts and block diagrams in the following Figures illustrate the architecture, functionality, and operation of possible implementations of systems, methods and computer program products according to various embodiments of the present disclosure. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items, and may be abbreviated as “/”.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Overview of the Optimization

The control problem that the herein disclosed systems, methods, and apparatus address considers both stability and tracking performance for a plant with significant nonlinearities and a high degree of uncertain dynamics (i.e., the plasma load is nonlinear and possibly chaotic). Optimization in this disclosure is split into two phases with the first using H_{∞} loopshaping to select parameters of the controller transfer function and the second phase optimizing for weights applied to the optimized controllers from the first phase. More specifically, in a first phase, controllers (e.g., H_{∞} controllers) are designed that optimize transient performance in the context of maintaining robustness guarantees for a predefined bound on the non-linearity in the system models. However, these designs make certain assumptions about system stability and data availability. The second phase sees controllers designed in a more generalized fashion such that weights can be selected to optimize a “generator stability region” with respect to cable length. In this way, users deploying a generator can calibrate the generator controller parameters and maximize stability during the generator commissioning rather than having to rely on a factor calibration.

Overview of System for Using Optimized Controller

The plasma processing system 400 includes a power generation system 402 that provides a multi-level pulsed waveform to a non-linear plasma load 404 based on a user-defined power output or target waveform 406. The power generation system (or “generator” for short) 402 can include a user interface 408, an optional master control unit (MCU) 410, a control section (e.g., an FPGA) 412, and power generation and sensors 414. A match network 416 can be arranged within the generator 402 (as shown) or outside the generator 402. The H_{∞} controller can be implemented as part of the control section 412.

A user desired power output, or target waveform, is provided to a user interface 408, which is optionally adjusted by a microcontroller unit (MCU) 410 to help with average power tracking, and passed to a control section 412. The MCU is used for relatively slow, high-level processing and complex algorithms, while the control section 412 is implemented in an FPGA or other high-speed electronics and handles simple control algorithms. Thus, where the MCU 410 is implemented, a two-loop control approach can be used with a fast inner loop implementing simple control algorithms, and more complex processes running on the slower outer loop. In some embodiments, the optimized controllers disclosed herein can alleviate the need for the MCU 410, in which case the target waveform can be provided directly to the control section 412.

The control section 412 uses real-time measurements to perform real-time setpoint tracking, thereby constituting the fast inner loop of the feedback control system. The control section 412 can also perform averaging of the feedback and provide the averaged measurements back to the MCU 410. The MCU 410 may use a proportional-integral-derivative controller. The MCU 410 can use the averaged feedback to modify the user- defined setpoint values, passing these modified values to the control section 412. The MCU 410 can be continuously updated with the goal of matching the average power delivered to the target waveform. The MCU 410 can be tailored to make the average power track a second order critically damped system.

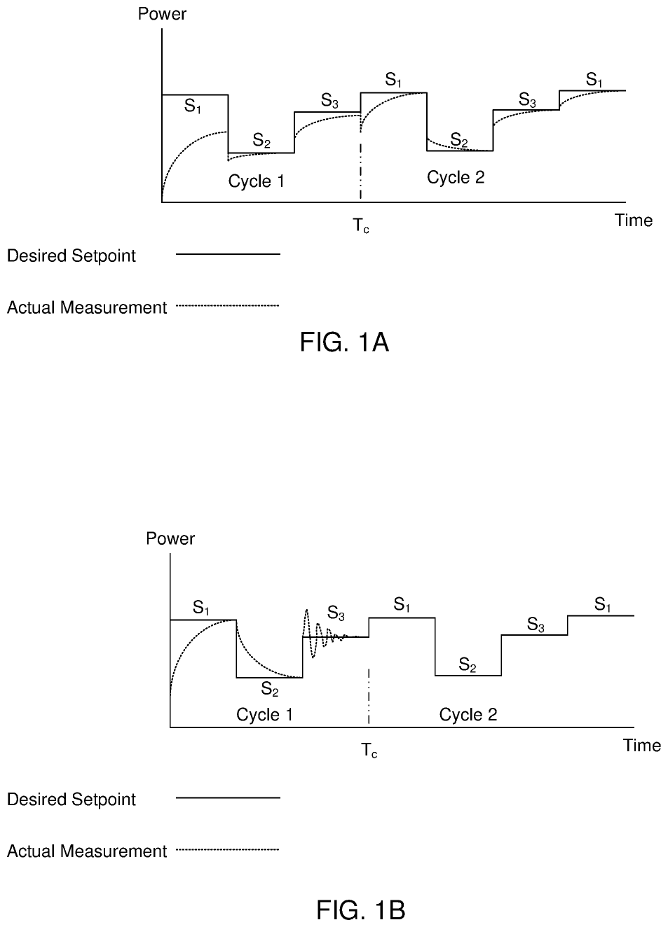

The control section 412 uses a multilevel pulsing algorithm for rail and drive/phase voltage. The goal of the algorithm is to minimize fluctuations in rail voltage, while keeping the value as low as possible, subject to keeping the drive/phase voltage close to its desired reference (or threshold) value. To implement this multilevel pulsing algorithm, the control section 412 can include controllers for rail voltage and drive/phase voltage. The H_{∞} controller 450 can reside within this control section 412, receive feedback from sensors in a power generation and sensors 414 and can help provide real-time control of the rail voltage and drive/phase voltage. These voltages are provided by a DC section and a power amplifier in the power generation and sensors 414. The DC section provides a rail voltage to the power amplifier, which provides granular adjustments to power output to track the target waveform (e.g., a pulsed multi-level waveform such as that seen in FIG. 1). A match network 416 can be arranged between the power generation and sensors 414 and a nonlinear and possibly chaotic plasma load 404 to enhance the efficiency of power delivery to the load. Although the match 416 is shown within the power generation system 402, in other embodiments, it can be arranged between the power generation system 402 and the nonlinear plasma load 404. The H_{∞} controller can be found via method 200 or 300 as discussed below.

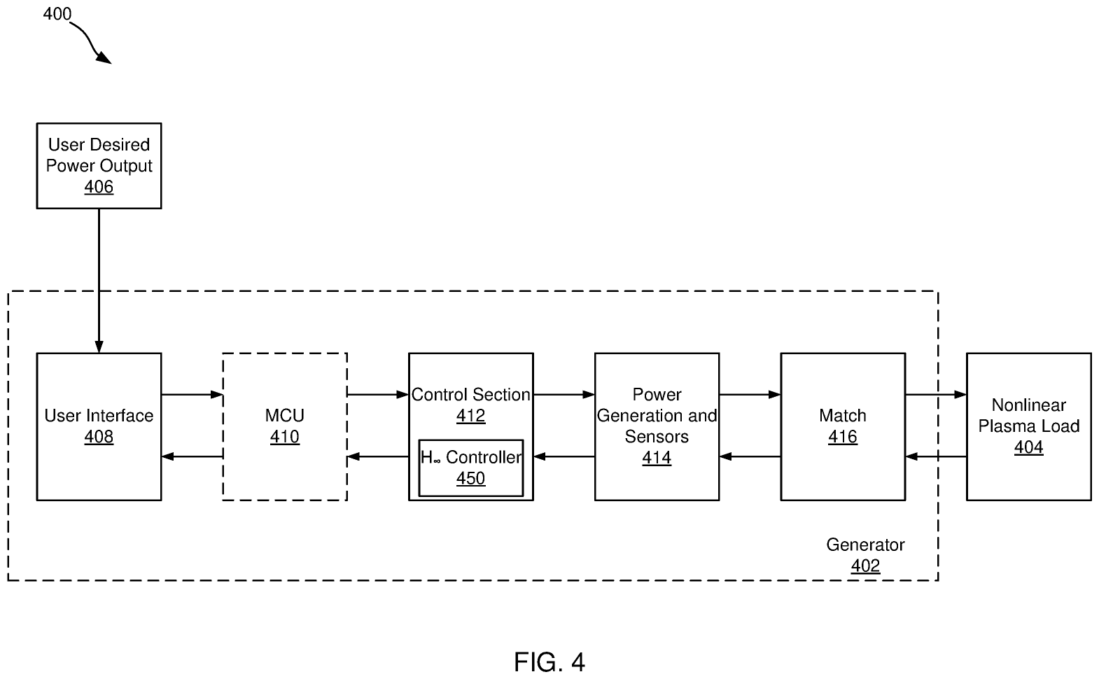

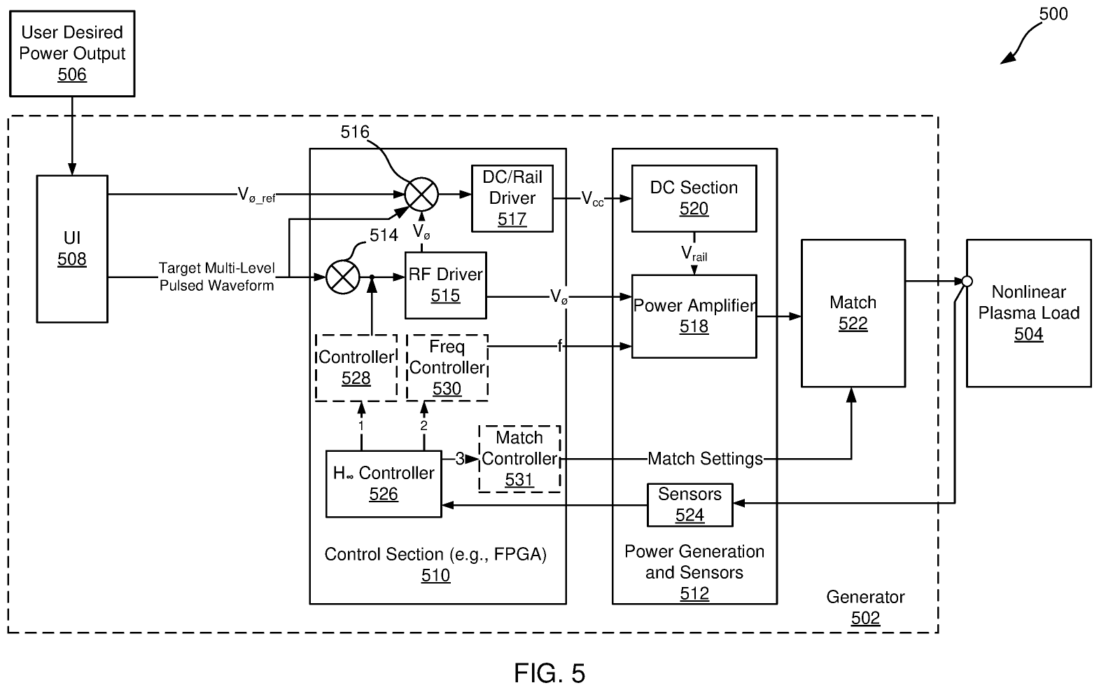

FIG. 5 provides additional details of the control section 412 and the power generation and sensors 414 of FIG. 4. The H_{∞} controller 526 designed by the method 200 or 300 (discussed below) can be implemented as a filter to an optional integrator 528, or where an integrator 528 is not used, the H_{∞} controller 526 can directly control an RF driver 515 in concert with a target multi-level pulsed waveform provided by the user through a user interface 506. Alternatively or additionally, the H_{∞} controller 526 can control an optional frequency controller 530, which provides frequency commands to a power amplifier 518. Alternatively or additionally, the H_{∞} controller 526 can control an optional match network controller 531, which provides match settings to the match network 522.

The UI 508 provides a phase/drive threshold or reference voltage, V_{ø_ref}, selected by the user as well as a target multi-level pulsed waveform (e.g., such as that seen in FIG. 1) to the control section 510. A “target waveform” will be used interchangeably with target multi-level pulsed waveform. The control section 510 includes controllers 514 and 516 as well as the RF driver 515 and a DC/rail driver 517. The H_{∞} controller 526 provides feedback control from sensors 524 as either a standalone controller or as a filter to another controller such as 528. The feedback takes measurements from the match network 522 output (or the chamber or nonlinear plasma load 504 or chamber input) through the H_{∞} controller 526. The RF driver 515 provides a phase/drive control signal, V_{ø} to a power amplifier 518 of the power generation and sensors 512, while the DC/rail driver 517 provides a rail voltage control signal, V_{CC}, to the DC section 520. The DC section 520 provides the rail voltage, Vᵣₐᵢₗ, to the power amplifier 518 that then uses the rail voltage, Vᵣₐᵢₗ, to track the target waveform and provide an output to the match network 522.

For the purposes of this disclosure, a nonlinear plasma load can be weakly nonlinear, strongly nonlinear, chaotic, or strongly nonlinear and chaotic. Traditional feedback systems are inoperable relative to strongly nonlinear and/or chaotic loads.

Overview of Method to Design Optimized Controller

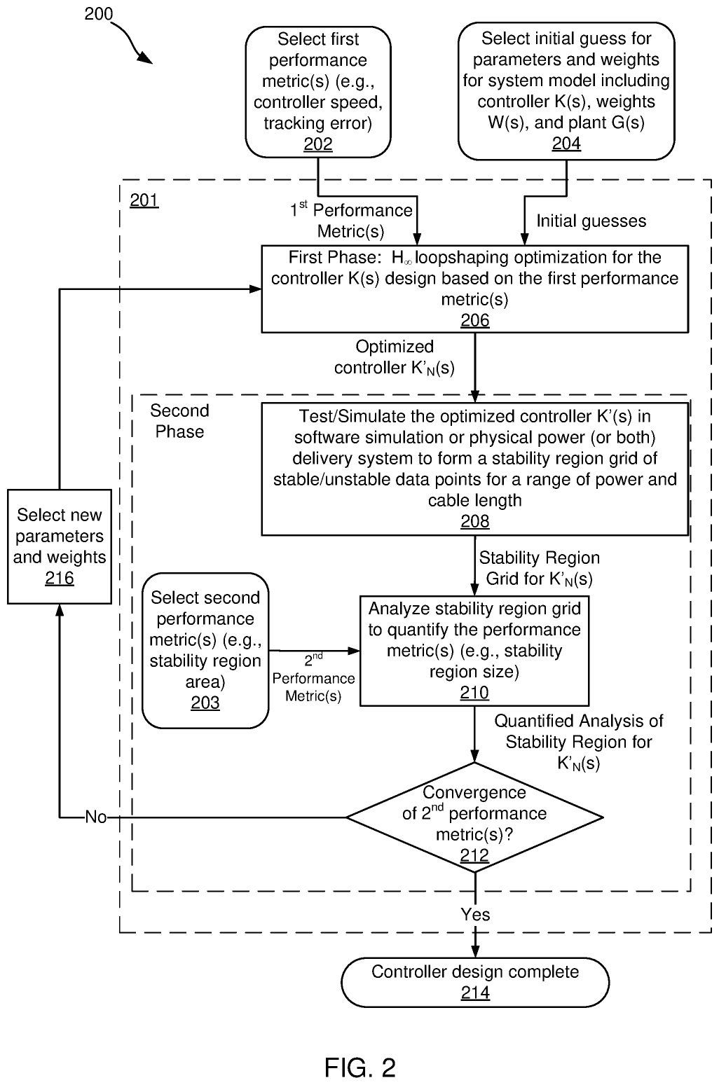

One embodiment of the optimization algorithm can be seen in FIG. 2. This algorithm can be used to design the H_{∞} controller 450 implemented in the system 400 of FIG. 4. The method 200 can start with selection of one or more first performance metrics (Block 202), as well as parameters and weights W(s) and a model of the plant G(s) (Block 204). A performance metric provides the optimization 201 a target or goal—some value to optimize by varying parameters of a model (equation or set of equations). Different performance metrics can favor different use case needs (e.g., absolute error tends to focus on real-time tracking whereas error metrics tend to focus on average tracking) depending on customer needs, and can therefore be selected by the customer, and need not be specified by this disclosure. For instance, mean absolute error may be preferred where average setpoint tracking is most important, whereas mean error may be more valuable where avoiding overshoot is important. Some non-limiting examples of the one or more first performance metrics include good tracking (or tracking speed), good disturbance attenuation, good noise rejection, and low controller energy use. Tracking can be broken into multiple sub-categories including, but not limited to, mean absolute error, mean error, mean accumulated error, mean moving error, where each form of the tracking error provides greater emphasis on certain design goals.

Initial parameters and weights W(s) can be selected based on customer needs (Block 204), including the selection of parameters and weights to apply to a model of the power generation system, or the plant G(s), based on a closed loop feedback controller K(s) that provides feedback to the driver/phase controller. The initial guesses can be random or based on preferred values (e.g., nominal values based on previous parameters or standard calibration methods). Some non-limiting examples of initial parameters can include Cₖ, Tₖ, Kₚ, and where Cₖ is a two-pole roll-off weight gain (DC gain), Tₖ is a time constant of the weight (or bandwidth), Kₚ is a proportional gain of the PI portion of the weight, and Kᵢ is an integral gain portion of the PI portion of the weight. These parameters can be optimized through the second phase of optimization seen in FIG. 2.

Weights W(s) are selected by the customer so that the shaped plant, Gₛ=W₂GW₁, has a desired loop shape magnitude, where G is the actual plant and represents a transfer function for the nonlinear plasma load. The weights W(s) can be further modified to include desired features of the controller (e.g., notches, integral action). One non-limiting example of a selected weight is given as:

$$W ( s ) = {{C}_{k} ( \frac{1}{1 + {sT}_{k}} )}^{2} ( {K}_{p} + \frac{{K}_{i}}{s} )$$

Where this definition of the weight shapes the DC gain via Cₖ, the bandwidth via Tₖ, and integrates a proportional-integral (PI) controller for low frequency and steady state tracking. The proportional and integral gains, Kₚ and K_{I}, determine how aggressively the tracking is pursued. A model of the plant G(s) can be selected, for instance, taking into consideration the dynamic perturbations accounted for via one of Equations 4-11 to be discussed in the next section.

These initial guesses are passed to the optimization 201, which has two different phases of optimization, starting with an H_{∞} loopshaping optimization 206 as the first phase. The first phase optimizes for controller stability and can be characterized by an equation—hence, the H_{∞} loopshaping optimization 206 can be applied. However, the second phase optimizes for stability in terms of the plasma (nonlinear and possibly chaotic) and cable length, which cannot be characterized by a simple equation (and may include some stochasticity). As such, the H_{∞} loopshaping optimization 206 is not applicable to this second phase of the optimization, and instead the disclosure uses an iterative simulation and convergence approach based on different or overlapping performance metrics to the first phase (see Blocks 208, 210, 212, and 216). In many embodiments, a novel stability region size or area is used as a performance metric (or one of the performance metrics) in this second phase. As will be seen, a stability region grid and analysis thereof, is used as an illustrative example of this second phase of the optimization 201. However, those of skill in the art will appreciate that other optimizations can be used for the second phase, and thus the disclosure is not limited to calculation and quantification of a stability region for the second phase of the optimization 201.

The first phase or loopshaping 206 produces an optimized controller, K′_{N}(s), or nominal controller, that is designed as a peak in variability of the parameters and dynamic structure of the controller. This can be done through a derivation procedure or “μ synthesis” for example, where μ synthesis can use robust control numerical methods. In other words, the optimized controller is designed for a worst-case scenario, or designed to maintain robust stability margins. This is partially what is meant by “robust:” a controller that can operate effectively within bounds or a worst-case scenario. Accordingly, the first phase of the optimization 201 is responsible for guiding the controller design toward a robust design and the generation of an optimized controller K′_{N}(s).

Details of the First Phase of Optimization

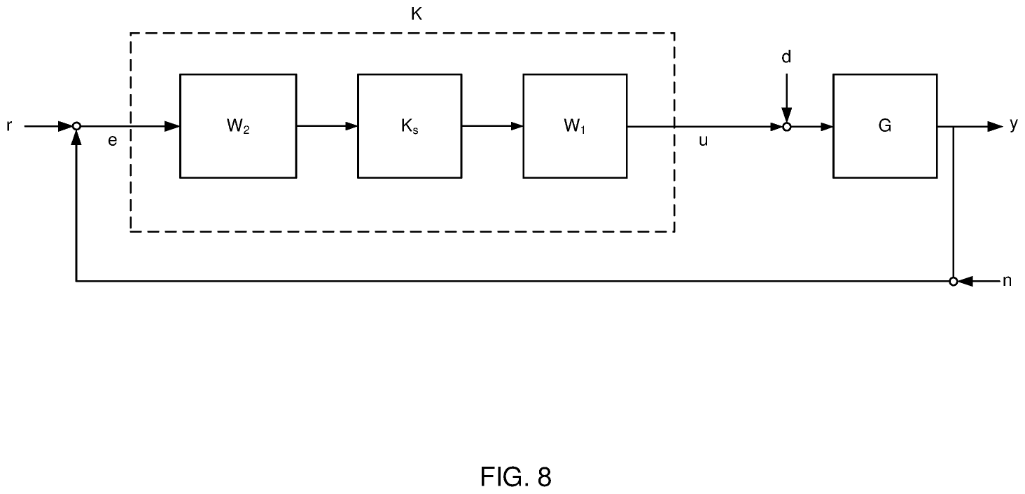

More specifically, a model of the controller, K, and the power generation and sensors (or plant) G, is shown in FIG. 8, and this model can be described by Equations 1, 2, and 3 for output y, control signal u, and error signal e, and the identity matrix I.

y=(I+GK)⁻¹GKr+(I+GK)⁻¹d−(I+GK)⁻¹GKn (Equation 1)

u=K(I+GK⁻¹r−K(I+GK)⁻¹d−K(I+GK⁻¹n (Equation 2)

e=(I+GK)⁻¹r−(I+GK⁻¹d−(I+GK)⁻¹n (Equation 3)

Other parameters of the model in FIG. 8 and seen in Equations 1-3 include reference input r, disturbance d, and measurement noise n. The parameters d and n can model nonlinearities in the system. The variables K and G can be written as a single variable for SISO systems and SISO systems described by state space models, or can be written as matrices for MIMO systems and/or MIMO systems described by state space.

This model can be further enhanced by accounting for dynamic perturbations in the plant G, for instance by selecting a model of the unstructured uncertainties of the plant, G, or a set of perturbed power generation systems 402 or plants, G(s) as they relate to the nominal model G₀(s) and some perturbation Δs. In an embodiment, these transfer functions can be selected from one of the following eight depending on design goals:

Right coprime factor perturbations:

G(s)=NM⁻¹=(N+Δ_{N})(M+Δ_{M})⁻¹ (Equation 4)

Left coprime factor perturbations:

G(s)=(\tilde{M}+Δ_{\tilde{M}})⁻¹(Ñ+Δ_{Ñ}) (Equation 5)

Inverse output multiplicative perturbation:

(G(s))⁻¹=(G₀(s)⁻¹)[I+ΔS] (Equation 6)

Inverse input multiplicative perturbation:

(G(s))⁻¹=[I+ΔS](G₀(s)⁻¹) (Equation 7)

Output multiplicative perturbation:

G(s)=[I+ΔS]G₀(s) (Equation 8)

Input multiplicative perturbation:

G(s)=G₀(s)[I+ΔS] (Equation 9)

Input additive perturbation:

(G(s))⁻¹=(G₀(s)⁻¹)+Δ(s) (Equation 10)

Additive perturbation:

G(s)=G₀(s)+Δ(s) (Equation 11)

Where G₀(s) is a nominal model description of the physical system, and where Δ_{N}(s) and Δ_{M}(s) are stable perturbations with bounded H_{∞} norm:

$$‖ ( \begin{matrix}{Δ}_{N} ( s ) \\ {Δ}_{M} ( s )\end{matrix} ) ‖ \leq \frac{1}{γ} \qquad ( Equation 12 )$$

The additive uncertainty representations (e.g., Equations 10-11) give an account of absolute error between actual dynamics and the nominal model, while the multiplicative representations (e.g., Equations 6-9) show relative errors. Further details of these plant definitions can be found in D.-W. Gu et al., Robust Control Design with MATLAB, Advanced Textbooks in Control and Signal Processing, DOI 10.1007/978-1-4471-4682-7_2. Springer-Verlag London 2013.

With this model in hand, the H_{∞} loopshaping (Block 206) optimizes for one or more first performance metrics that may include, but is not limited to, any one or more of tracking, disturbance attenuation, noise rejection, and less control energy. In other words, the H_{∞} loopshaping can minimize for one or more of the following:

good tracking:

∥(I+GK)⁻¹∥_{∞} (Equation 13)

good disturbance attenuation:

∥(I+GK)⁻¹∥_{∞} (Equation 14)

good noise rejection:

∥(I+GK)⁻¹GK∥_{∞} (Equation 15)

less energy controller:

∥K(I+GK)⁻¹∥_{∞} (Equation 16)

Each of these four norms are derived from Equations 1-3, and one sees that good tracking and good disturbance attenuation are minimized by the same function, for instance minimizing the influence of disturbance, d, on the output y in Equation 1. Similarly, minimizing for noise rejection via Equation 15 means minimizing the influence of noise, n, in Equation 1. Where one or more of the above are to be used for the first performance metric, they can be combined into a mixed sensitivity problem, such as Equation 17 for good tracking and low control signal energy:

$$K \begin{matrix}min \\ stabilizing\end{matrix} {‖ \frac{{( I + GK )}^{- 1}}{{K ( I + GK )}^{- 1}} ‖}_{∞} \qquad ( Equation 17 )$$

This example cost function can also be interpreted as the design objectives of nominal performance, good tracking or disturbance attenuation, and robust stabilization, with regard to additive perturbation. Those of skill in the art will appreciate that Equation 17 is an example only, and that other optimization norms for other combinations of the metrics represented by Equations 13-16 can also be used.

Additionally, it will also be appreciated that a sensitivity function is defined as:

S:=(I+GK)⁻¹ (Equation 18)

And a complementary sensitivity function is defined as:

[symbol]

:=(I+GK)⁻¹ GK (Equation 19)

Since the sum of the sensitivity function and the complementary sensitivity function is 1, increasing S leads to a decrease in [symbol] and vice versa. Accordingly, it is not trivial to optimize for any of Equations 13-16 since the sensitivity and complementary sensitivity functions move in opposite directions. Since the sensitivity and complementary sensitivity functions optimize in opposite directions, one can optimize over specific frequency ranges via use of weights, W₁ and W₂. More specifically, the first weight, W₁, can be chosen as a high-gain low-pass filter type as seen in Equation 20, and W₂ is often set to 1.

$$K \begin{matrix}min \\ stabilizing\end{matrix} {‖ {W}_{1} {SW}_{2} ‖}_{∞} \qquad ( Equation 20 )$$

Where one recalls that the weights are optimized in the second phase, not in the H_{∞} loopshaping. Said another way, the first phase of optimization seeks to minimize the sensitivity function, S, at low frequency, and minimize the complementary sensitivity function, [symbol] at high frequency (since disturbance d is a low-frequency phenomena, and noise n is a high frequency phenomena), and to do this, the first weight, W₁, tends to be high at low frequency and low at high frequency. The second weight, W₂, can be arbitrary selected or can be optimized.

The H_{∞} loopshaping optimization 206 can use λ or μ numerical methods to determine static parameters or a dynamic structure of the controller K(s) such that the optimization 206 ensures that given a certain level of uncertainty (parametric or dynamic) of the power generation system (e.g., 402) is guaranteed to achieve the desired first performance metric(s) (e.g., speed of response and tracking capability) in real time in the worst-case scenario. The optimization 206 may also find an optimized controller K′(s) that can perform better than the worst-case scenario.

Having selected one or more first performance metrics, the H_{∞} loopshaping optimization (e.g., normalized coprime factor synthesis approach, among others), can be used in a first phase of the disclosed optimization algorithm to produce an optimized controller K(s) (Block 206) that can be further optimized via a second portion of the disclosed optimization algorithm. In loop-shaping the controller structure and gains are selected such that the magnitude of the frequency response of the open loop transfer function has particular characteristics—or a particular shape. The controller K(s) is obtained as the solution to the H_{∞} optimal control problem shown in FIG. 8. The controller K and the shaped plant Gₛ can be defined as:

K=W₁K_{S}W₂ (Equation 21)

Gₛ=W₂GW₁ (Equation 22)

The H_{∞} optimal controller synthesis solution provides Kₛ solving for the global minimum of the selected first performance metric or selected first mixed performance metric, and the resulting optimized controller K′_{N}(s) provides robust stability to coprime factor uncertainty for the shaped plant Gₛ, with robustness level Y.

One can think of the whole optimization (first and second phases) as selecting the weights, W₁ and W₂, so that the shaped plant, Gₛ=W₂GW₁ has a desired loop shape magnitude. The controller K=W₁KₛW₂ will provide the same loop shape magnitude and stability margins for the original plant G. Hence the term loopshaping—one simply chooses the desired loop shape magnitude and the H_{∞} optimization and second phase of optimization solves for the controller that delivers as close to that as it can, whilst still having good robust stability margins. Desired features in the controller can be included in the weights, W₁ and W₂. With a better appreciation of the options available in the first phase 206 of the optimization 201, one can next turn to details of the second phase of the method 200 (i.e., how is the optimized controllers K′_{N}(s) further optimized in terms of the weights W(s)).

Details of the Second Phase of Optimization

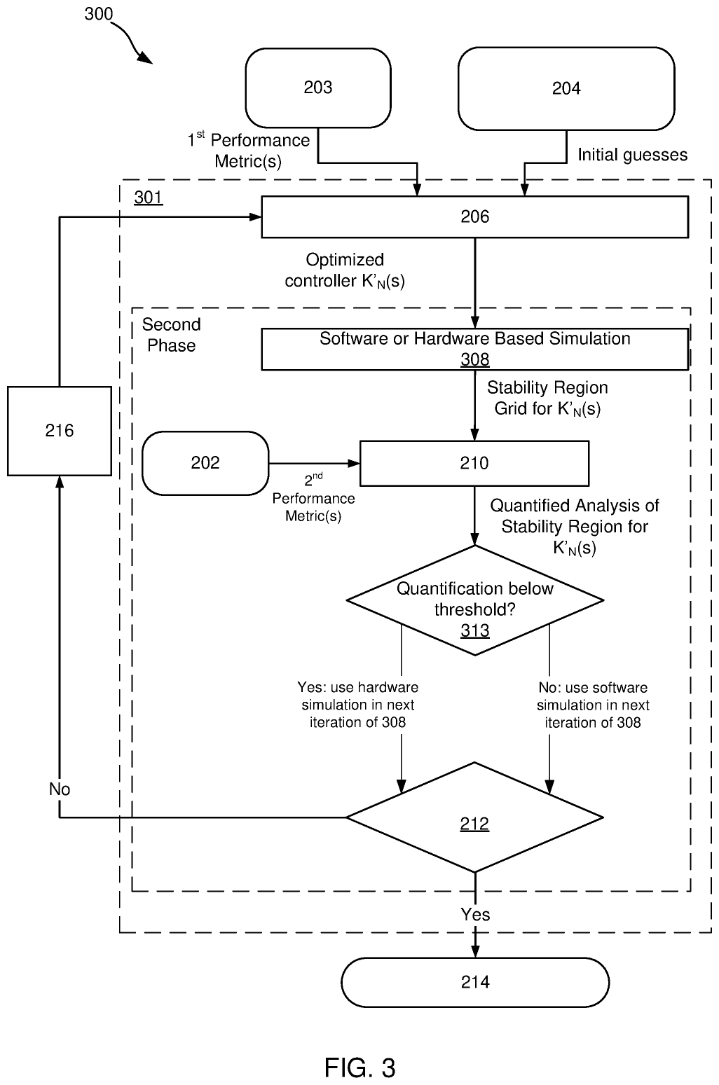

The second phase of the optimization 201 determines the parameters that make up the weight function W(s), for instance, the parameters Cₖ, Tₖ, Kₚ, and Kᵢ. More specifically, the second phase begins with the test or simulation 208, which can be carried out on a test bed in software, hardware, or both. This test bed should simulate or be a customer's physical system (e.g., a plasma processing system). For instance, the first optimized controller K′₁(s) can be tested on a physical power generation system providing pulsed power to a plasma load, or simulated in software modeling a physical power generation system in concert with a simulated plasma load. In other embodiments, the simulation can start on software, and later switch to hardware-based simulation, for instance, when the convergence 212 falls below a threshold, but has yet reached convergence (i.e., 212=No, but the convergence value is below a threshold). One embodiment of this alternative optimization 301 is shown in FIG. 3, where simulation 308 can be hardware-based or software-based depending on the quantification from analysis 210 falling at or below a threshold as determined by decision 313. In one embodiment, the software portion of this hybrid approach can be implemented on a “digital twin” as disclosed in co-pending U.S. Patent Application No. 63/178,865, and incorporated herein by reference in its entirety.

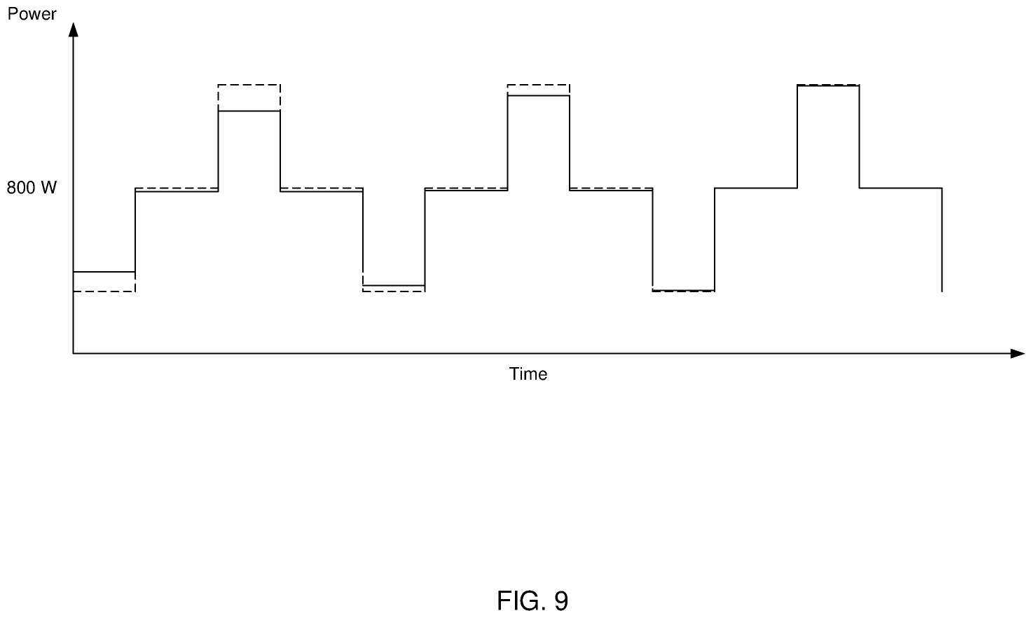

In some embodiments, the simulation can include simulating a target waveform (a target simulated waveform) of pulsed power with at least one pulse above and below a setpoint power, such as 800 W, for a given cable length or impedance rotation angle, and monitoring whether the optimized controller K′_{N}(s) tracks the target waveform within thresholds of error (e.g., average tracking error . . . often within 10%) and time (e.g., see FIG. 9). For instance, the simulation can test whether the average response settles within a specified error range and within a specific time interval. The example waveform shown in FIG. 9 tests the controller's ability to track rising and falling edges with the target waveform shown in a dashed line, and the controller's ability to track the waveform shown in a solid line, though other waveforms can also be used in the simulation. If tracking of the target waveform is successful within the error and time thresholds, then the data point is deemed “stable,” and if not, the data point is deemed “unstable.” Said another way, each point in the stability region grid can be calculated, in an embodiment, by testing a step response to power set point and cable length and calculating an average tracking error for each grid point.

For the simulation, a slow rail controller and a fast drive/phase controller can be assumed with the form:

$$G ( s ) = \frac{{C}_{p}}{1 + sTp} \qquad ( Equation 23 )$$

Where Cₚ and Tₚ are open loop parameters.

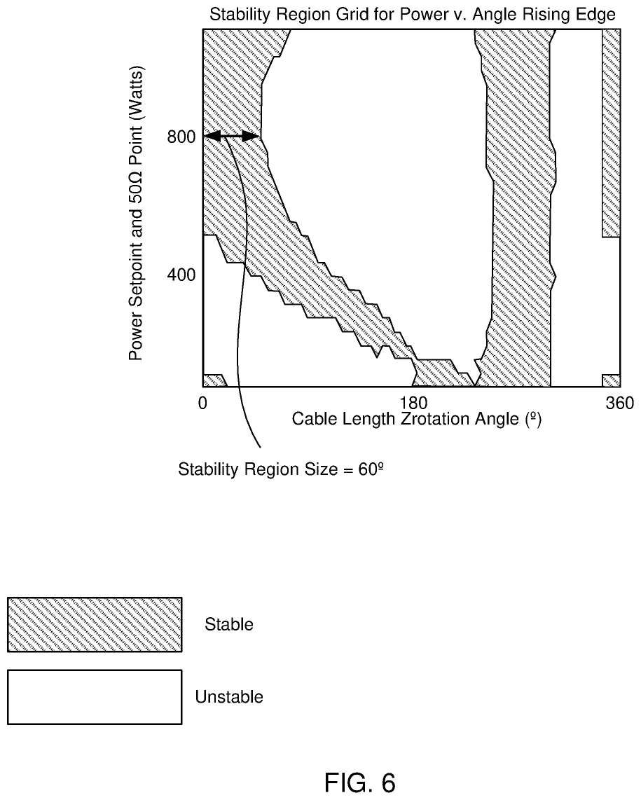

This simulation can be performed for each combination of power setpoint and cable length to form a stability region grid. An example of such a grid is shown in FIG. 6, where the cross-hatched regions represent stable regions and the white regions represent unstable regions. The range of power and cable length can be determined based on use case. In some embodiments, the simulations to form the grid can be performed serially while in others they can be performed in parallel as will discussed in more detail later in this disclosure.

The stability region grid for the first optimized controller K′₁(s) can be analyzed (Block 210) and that, along with a selection of a desired one or more second performance metrics 203 (e.g., stability region size/area), provides a qualitative value associated with the stability region grid. For instance, this second performance metric can be stability region size at a particular power. FIG. 6 shows the size of the stability region being calculated at 800 W. However, in other examples, a stability region area could be the second performance metric, for instance where the stability region area is calculated as a largest area of stability in the grid. In one embodiment, the one or more second performance metrics can include stability size or stability region area along with one or more of the first performance metrics (e.g., controller speed). In other words, the second phase can include one or more unique performance metrics, but may optionally also include one or more of the performance metrics used by the first phase.

The quantified analysis can be passed to a convergence decision 212, which looks to see whether quantitative values for the one or more second performance metrics are converging as compared to previous optimized controllers. Convergence is not possible for the first optimized controller K′₁(s) since no previous results are available to compare to. As such, Decision 212=No, and new parameters and weights are selected 216 to feed into a second loop of the optimization 201. Thus ends the second phase, and a return to the first phase or the H_{∞} optimization 206. The new weights and parameters can be selected in a linear fashion, based on a more complex relation to previous values, or arbitrarily. This selection will be based on the type of convergence algorithm being pursued and is not limiting of the optimization 201.

In the second loop of the optimization 201, the H_{∞} loopshaping optimization 206 produces a second optimized controller K′₂(s) based on the newly-selected parameters and weights from 216. This second optimized controller K′₂(s) is then passed through the test/simulation 208 to produce a second stability region grid that is analyzed 210 based again on the second performance metric. The value returned from this analysis 210 is compared to the value from the first loop through the optimization 201 and convergence is determined 212, which is also typically not possible on this second loop. At least a third loop is needed in most embodiments before convergence is possible (i.e., 212=Yes).

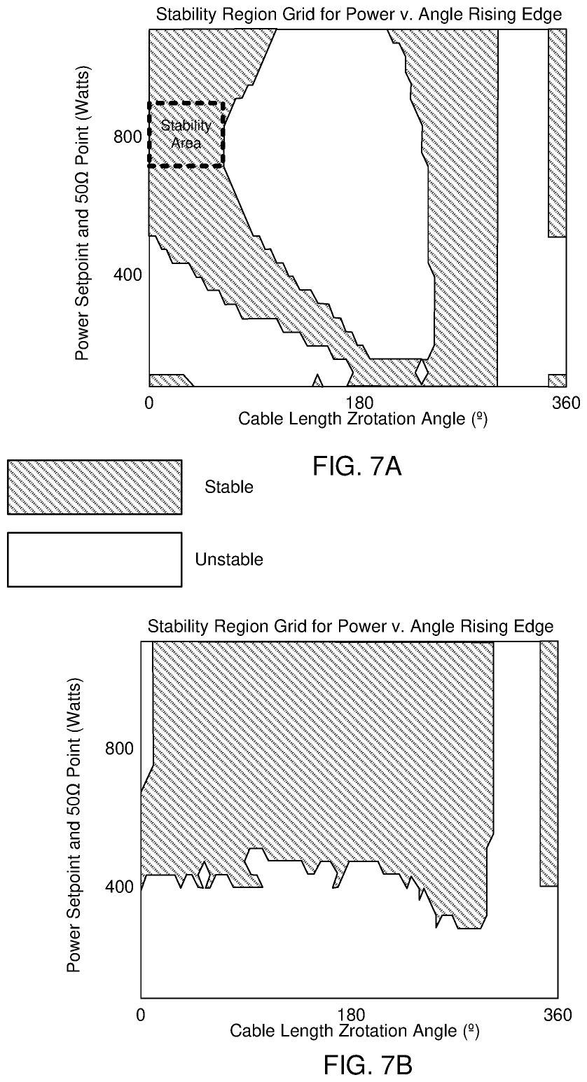

The convergence determination 212 looks at the one or more second performance metrics selected in 203. For instance, the selected performance metric could be stability region area, and FIG. 6 shows the stability region grid for the first optimized controller K′₁(s), FIG. 7A shows the stability region grid for the second optimized controller K′₂(s), and FIG. 7B shows the stability region grid for the third optimized controller K′₃(s). As one can see, the stability region area has grown significantly, and increased stability region area may be unlikely. Thus, convergence may be achieved with the third optimized controller K′₃(s) or soon thereafter.

It should also be noted that, where stability region size or area is used as the second performance metric, the power setpoint (for stability region size) or range of power setpoints (for stability region area) is selected as part of the second performance metric. For instance, where stability region area is used, a range of 800-1000 W could be selected, which in FIG. 7B would provide a highly stable result and likely convergence with the third optimized controller K′₃(s), or at most within a few additional iterations. On the other hand, if the range had been selected to be 200-400 W (e.g., for a lower powered system), then the third optimized controller K′₃(3) would show a very small stability region and thus this solution would appear to be far from convergence. Such a poor result on a third iteration could be the result of overshoot by the selected weights and parameters, for instance, where 216 lead the optimization 201 to jump past a global optimum, and might result in the next set of parameters and weights backtracking toward those used to produce the second iteration shown in FIG. 7B.

Once convergence has occurred (Decision 212=Yes), the optimized controller K′_{N}(s) for that iteration (the N^{th} iteration) is selected as the final design (Block 214), and this ends the second phase and thus the optimization 201. The final controller design can be written as:

$$K ( s ) = {K}_{noi} ( s ) ( \frac{1}{s} ) \qquad ( Equation 24 )$$

With the final weight, W(s) written as:

$$W ( s ) = {{C}_{k} ( \frac{1}{1 + {sT}_{k}} )}^{2} ( {K}_{p} + \frac{{K}_{i}}{s} ) = ( \frac{{C}_{k} ( {K}_{p} s + {K}_{i} )}{{( 1 + {sT}_{k} )}^{2}} ) ( \frac{1}{s} ) = {W}_{noi} ( s ) ( \frac{1}{s} ) \qquad ( Equation 25 )$$

The final controller can be implemented as the H_{∞} controller 450 or 550. (e.g., in an FPGA program).

To reduce latency and allow for more real-time target waveform tracking, the simulations 208 to form the stability region grid for the optimized controller K′_{N}(s), can be parallelized. For instance, the “parsim” command in MATLAB can be used to process multiple stability region grid points in parallel.

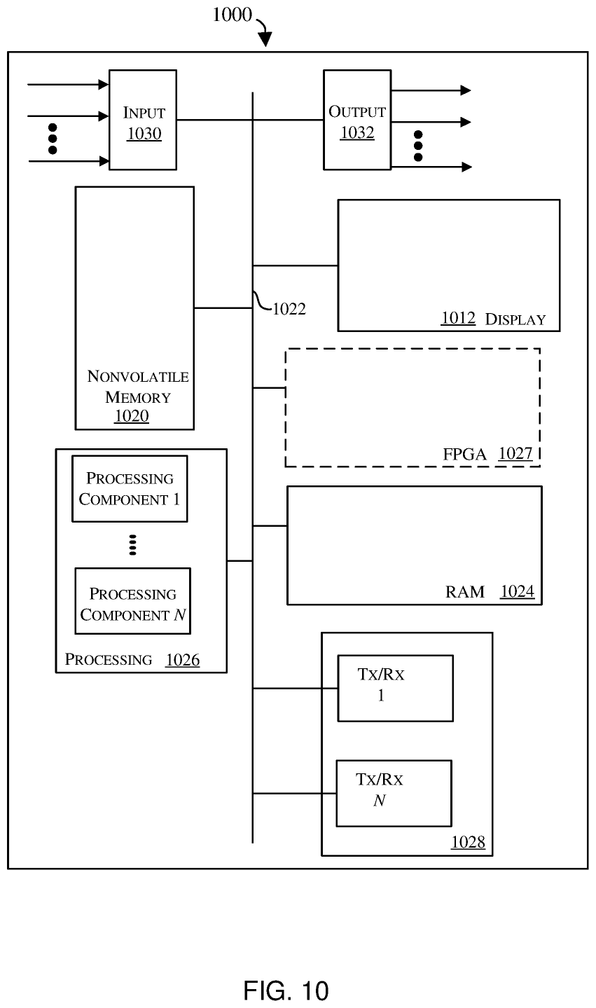

The methods described in connection with the embodiments disclosed herein may be embodied directly in hardware, in processor-executable code encoded in a non-transitory tangible processor readable storage medium, or in a combination of the two. Referring to FIG. 10 for example, shown is a block diagram depicting physical components that may be utilized to realize the H_{∞} controller (and the controller section generally) according to an exemplary embodiment. As shown, in this embodiment a display portion 1012 and nonvolatile memory 1020 are coupled to a bus 1022 that is also coupled to random access memory (“RAM”) 1024, a processing portion (which includes N processing components) 1026, an optional field programmable gate array (FPGA) 1027, and a transceiver component 1028 that includes N transceivers. Although the components depicted in FIG. 10 represent physical components, FIG. 10 is not intended to be a detailed hardware diagram; thus many of the components depicted in FIG. 10 may be realized by common constructs or distributed among additional physical components. Moreover, it is contemplated that other existing and yet-to-be developed physical components and architectures may be utilized to implement the functional components described with reference to FIG. 10.

This display portion 1012 generally operates to provide a user interface for a user, and in several implementations, the display is realized by a touchscreen display. In general, the nonvolatile memory 1020 is non-transitory memory that functions to store (e.g., persistently store) data and processor-executable code (including executable code that is associated with effectuating the methods described herein). In some embodiments for example, the nonvolatile memory 1020 includes bootloader code, operating system code, file system code, and non-transitory processor-executable code to facilitate the execution of a method described with reference to FIGS. 2 and 3 described further herein.

In many implementations, the nonvolatile memory 1020 is realized by flash memory (e.g., NAND or ONENAND memory), but it is contemplated that other memory types may be utilized as well. Although it may be possible to execute the code from the nonvolatile memory 1020, the executable code in the nonvolatile memory is typically loaded into RAM 1024 and executed by one or more of the N processing components in the processing portion 1026.

The N processing components in connection with RAM 1024 generally operate to execute the instructions stored in nonvolatile memory 1020 to enable operation of an H_{∞} controller. For example, non-transitory, processor-executable code to effectuate the methods described with reference to FIGS. 2 and 3 may be persistently stored in nonvolatile memory 1020 and executed by the N processing components in connection with RAM 1024. As one of ordinarily skill in the art will appreciate, the processing portion 1026 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 1026 may be configured to effectuate one or more aspects of the methodologies described herein (e.g., the method described with reference to FIGS. 2 and 3). For example, non-transitory processor-readable instructions may be stored in the nonvolatile memory 1020 or in RAM 1024 and when executed on the processing portion 1026, cause the processing portion 1026 to perform a method of implementing an H_{∞} controller designed by either the method 200 or 300. Alternatively, non-transitory FPGA-configuration-instructions may be persistently stored in nonvolatile memory 1020 and accessed by the processing portion 1026 (e.g., during boot up) to configure the hardware-configurable portions of the processing portion 1026 to effectuate the functions of the H_{∞} controller or the control section 412 more generally.

The input component 1030 operates to receive signals (e.g., the target waveform or power setpoint) that are indicative of one or more aspects of the desired generator 402 output. The signals received at the input component may include, for example, a target waveform. The output component generally operates to provide one or more analog or digital signals to effectuate an operational aspect of the H_{∞} controller or control section 412.

The depicted transceiver component 1028 includes N transceiver chains, which may be used for communicating with external devices via wireless or wireline networks. Each of the N transceiver chains may represent a transceiver associated with a particular communication scheme (e.g., WiFi, Ethernet, Profibus, etc.).

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A generator comprising:
a power generation section;
a match network coupled to an output of the power generation section; and
a control section configured to receive a target waveform and configured to receive feedback from an output of the generator, the control section comprising:
an optimized controller designed using a two-part optimization where each iteration of the optimization sees (1) a first optimization for a model controller based on a first one or more performance metrics that forms an optimized controller K′_{N}(s), and (2) a second optimization of weights for the optimized controller based on a second one or more performance metrics, where N identifies the iteration;
wherein the optimized controller receives the feedback and the target waveform, and controls an output of the power generation section based on the feedback and the target waveform.

2. The generator of claim 1, wherein the second optimization generates a stability region grid in terms of power setpoint and cable length.

3. The generator of claim 2, wherein the stability region grid is formed by simulating the optimized controller K′_{N}(s) providing control signals to the power generation section in operation or a software-simulated version of the power generation section in operation.

4. The generator of claim 1, wherein the stability region grid comprises an array of stable and unstable points, where stable is defined in terms of simulated operation of the optimized controller K′_{N}(s) meeting a threshold of error and time in tracking a target simulated waveform.

5. The generator of claim 1, wherein the second one or more performance metrics include one or more of the first one or more performance metrics.

6. The generator of claim 1, wherein the optimized controller also controls the match network based on the feedback and the target waveform.

7. A method comprising:
forming a model for a controller of a power supply configured to deliver power to a strongly nonlinear and/or chaotic plasma load;
selecting a first one or more performance metrics for optimizing the controller;
selecting initial guesses of weights and parameters of the model;
performing an initial H_{∞} loopshaping optimization of the model where the weight and parameters of the model are variables to be optimized to form an optimized model of the controller;
simulating the optimized model of the controller for a range of power setpoints and cable lengths between the power supply and the strongly nonlinear and/or chaotic plasma load to form a stability region grid comprising a grid of stable and unstable points;
selecting a second one or more performance metrics;
analyzing the stability region grid to quantify performance of the optimized model of the controller in terms of the second one or more performance metrics; and
selecting new weights and parameters for the model and repeating the performing, the simulating, the selecting, and the analyzing, until performance of the optimized model of the controller converges.

8. The method of claim 7, further comprising:
taking a cable length of a cable between a physical power supply and a processing chamber configured to generate a strongly nonlinear and/or chaotic plasma load, and identifying corresponding optimized parameters based on parameters that led to the optimized controller; and
setting a controller device of the physical power supply using the optimized parameters.

9. The method of claim 7, wherein the analyzing the stability region grid optimizes for the weights.

10. The method of claim 9, wherein the analyzing the stability region grid optimizes the parameters that define the weights.

11. The method of claim 7, wherein the first one or more performance metrics comprises at least one of: tracking speed, disturbance attenuation, noise rejection, and low controller energy use.

12. The method of claim 11, wherein the analyzing the stability region grid comprises analyzing the stability region grid over a range of power setpoints.

13. The method of claim 11, wherein the analyzing the stability region grid comprises analyzing the stability region grid over a range of power setpoints and wherein the second performance metric includes at least one of the first one or more performance metrics.

14. The method of claim 7, wherein the weights are based on at least a two-pole roll-off weight gain, a bandwidth of the weights, or a proportional gain of a proportional-integral portion of the weights and an integral gain of the proportional-integral portion of the weights.

15. The method of claim 7, wherein the performing optimizes for controller stability.

16. The method of claim 15, wherein the simulating and analyzing optimizes for controller stability in terms of the plasma and cable length.

17. The method of claim 7, wherein the H_{∞} loopshaping optimization minimizes a sensitivity function modified by the weights at low frequency, and minimizes a complementary sensitivity function at a high frequency, and the analyzing the stability region grid optimizes the weights in an iterative fashion.

18. The method of claim 7, wherein the simulating comprises using the initial H_{∞} loopshaping optimization of the model and the initial guesses of the weights and parameters of the model to deliver power from the power supply to the strongly nonlinear and/or chaotic plasma load.

19. The method of claim 7, wherein the simulating comprises using the initial H_{∞} loopshaping optimization of the model and the initial guesses of the weights and parameters of the model to simulate in software delivery of power from a simulated power supply to a simulated strongly nonlinear and/or chaotic plasma load.

20. The method of claim 7, wherein stable is defined in terms of a simulated waveform settling within a threshold error of a target waveform within a threshold time.
